(19) United States
(12) Patent Application Publication
(10) Pub. No.: US 2013/0076624 A1
(43) Pub. Date: Mar. 28, 2013

(54) COORDINATE INPUT APPARATUS, CONTROL METHOD THEREOF AND COORDINATE INPUT SYSTEM

(71) Applicant: Hajime Sato, Yokohama-shi (JP)

(72) Inventor: Hajime Sato, Yokohama-shi (JP)

(73) Assignee: CANON KABUSHIKI KAISHA, Tokyo (JP)

(21) Appl. No.: 13/612,483

(22) Filed: Sep. 12, 2012

(30) Foreign Application Priority Data
Sep. 28, 2011 (JP) 2011-213379

(51) Int. Cl. G06F 3/033

(52) U.S. Cl. 345/157

(57) ABSTRACT

This invention provides a coordinate input apparatus which improves the operability of a touch operation. The coordinate input apparatus according to the present invention comprises: a determination unit configured to periodically determine whether a pointer exists in a detection region; a derivation unit configured to derive a coordinate value of the pointer; a detection unit configured to detect incoming of the pointer to the detection region and outgoing of the pointer from the detection region; and an output unit configured to output an event signal representing outgoing of the pointer together with a coordinate value associated with the outgoing, wherein the coordinate value associated with the outgoing is corrected by using a coordinate value derived by the derivation unit upon detecting incoming prior to the outgoing.

### BACKGROUND OF THE INVENTION

1. Field of the Invention

The present invention relates to a technique of determining a pointed position in a coordinate input region.

2. Description of the Related Art

There is a coordinate input apparatus which inputs coordinates by pointing on a coordinate input surface using a pointer (for example, a dedicated input pen or finger). The coordinate input apparatus is used to control a computer or input characters, graphics, and the like. Various types of coordinate input apparatuses have been proposed and commercialized as touch panel apparatuses. These coordinate input apparatuses are widely used because a terminal such as a personal computer (PC) can be easily operated on the screen without using a special tool or the like. Detection methods in coordinate input apparatuses vary from a method using a resistive film to a method using an ultrasonic wave. An example is a method using light (U.S. Pat. No. 4,507,557 (literature 1)). In literature 1, a retroreflective sheet is formed outside a coordinate input region. Illumination units for emitting light, and light-receiving units for receiving light are arranged at corner end portions of the coordinate input region. The illumination units and light-receiving units detect angles defined by the light-receiving units and an occulting material such as a finger which occults light in the coordinate input region. Based on the detection results, the pointed position of the occulting material is determined.

Japanese Patent Laid-Open Nos. 2000-105671 (literature 2) and 2001-142642 (literature 3) disclose coordinate input apparatuses in which a retroreflective member is arranged around a coordinate input region and the coordinates of a portion (light-shielding portion) where retroreflected light is shielded is detected. For example, in literature 2, the peak of a light-shielding portion by an occulting material that is received by a light-receiving unit is detected by waveform processing calculation such as differentiation, thereby detecting the angle of the light-shielding portion with respect to the light-receiving unit. The coordinates of the occulting material are calculated from the detection result. Literature 3 discloses an arrangement in which one end and the other end of a light-shielding portion are detected by comparison with a specific level pattern, and the center between these coordinates is detected.

In the light-shielding coordinate input apparatus, an optical path surface is formed from illumination units for emitting light, retroreflective portions for reflecting the light, and light-receiving units for receiving light. The optical path surface has a predetermined width (height) almost parallel to the input surface. An input to the optical path surface by the pointer is detected immediately before the pointer touches the input surface or immediately after it is released from the input surface. When the user writes a character, the locus trails before and after he touches the input surface. To prevent this, Japanese Patent Laid-Open No. 2001-84106 (literature 4) discloses an arrangement in which two-dimensional coordinates are detected as a pointer state, and distance information (depth information) with respect to the coordinate input/detection region surface is also detected to determine whether the pointer is inserted. Japanese Patent Laid-Open No. 2001-147776 (literature 5) discloses an arrangement in which a threshold used to determine whether the pointer has been inserted to the coordinate input/detection region is changed based on the distance between the pointer and an optical unit. Further, Japanese Patent No. 4401737 (literature 6) discloses an arrangement having a coordinate input surface formed from planes at different coordinate input surface levels. In this arrangement, whether the pointer such as a finger has touched the coordinate input surface is determined from the level and position information of the plane, a detected coordinate value, and a change of the distribution of light received by a sensor.

However, even by using the techniques disclosed in literatures 4 to 6, a detected position may slightly shift from a position where the pointer touched the input surface. Since the detection surface and input surface exist in different layers, coordinates at which it is sensed that the user pointed the input surface using the pointer, and actually detected coordinates on the detection surface sometimes shift from each other. The shift leads to a failure in pressing a button though the user operated (that is, pressed) a button object displayed on the screen.

FIG. 11 is a sectional view showing the input surface of an optical coordinate input apparatus. The optical path is represented as a region between a lower limit level LL and an upper limit level UL in detection. A coordinate position is determined on a detection surface at a level Lₜₕᵣ at which the coordinate input apparatus reacts to detect an input. Assume that a button object 123 is displayed as an image in a region 12D on an input surface 122. When the user moves a pointer along an input locus 121 to press the button object 123, no object event occurs though he has touched the button object 123. This is because a coordinate value 12A (with a down event) falls within the region 12D, but a coordinate value 12B (with an up event) falls outside the region 12D, and thus the event is canceled. That is, to execute the event of the button object 123, both the coordinate value 12A (with a down event) and the coordinate value 12B (with an up event) need to fall within the region 12D of the button object 123. In this way, even if the user thinks that he correctly operated the coordinate input apparatus, an object event expected by him does not occur, affecting the operability.

### SUMMARY OF THE INVENTION

The present invention provides a coordinate input apparatus which improves the operability of a touch operation.

According to one aspect of the present invention, a coordinate input apparatus comprises: a determination unit configured to periodically determine whether a pointer exists in a detection region arranged in a top layer of an input surface; a derivation unit configured to derive a coordinate value of the pointer when the determination unit determines that the pointer exists in the detection region; a detection unit configured to detect incoming of the pointer to the detection region and outgoing of the pointer from the detection region based on a change of presence/absence of the pointer by the determination unit; and an output unit configured to output an event signal representing outgoing of the pointer together with a coordinate value associated with the outgoing when the detection unit detects the outgoing of the pointer, wherein the coordinate value associated with the outgoing is a coordinate value obtained by correcting a coordinate value derived by the derivation unit upon detecting the outgoing by using a coordinate value derived by the derivation unit upon detecting incoming prior to the outgoing.

According to another aspect of the present invention, a coordinate input apparatus comprises: a detection unit configured to detect incoming and outgoing of a detection target to and from a coordinate detection region arranged at a top of an input surface; a calculation unit configured to calculate a third coordinate value using a first coordinate value obtained when the detection target is detected to have come into the detection region, and a second coordinate value obtained when the detection target goes out from the detection region; and an output unit configured to output the third coordinate value calculated by the calculation unit.

The present invention can provide a coordinate input apparatus which improves the operability of a touch operation.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing the schematic arrangement of a coordinate input apparatus according to the first embodiment;

FIG. 2 is a view for explaining the arrangement of a sensor unit;

FIG. 3 is a block diagram showing a control/calculation unit;

FIG. 4 is a timing chart showing light emission;

FIG. 5 is a graph for explaining a detected light amount distribution;

FIG. 6 is a view for explaining a region capable of coordinate calculation;

FIG. 7 is a view for explaining coordinate calculation;

FIGS. 8A and 8B are flowcharts showing control of the coordinate input apparatus according to the first embodiment;

FIG. 9 is a view for exemplarily explaining correction of a coordinate value associated with an event;

FIGS. 10A and 10B are flowcharts showing details of an output event & coordinate determination processing step (step S123); and

FIG. 11 is a view for explaining a conventional problem.

### DESCRIPTION OF THE EMBODIMENTS

Preferred embodiments of the present invention will now be described in detail with reference to the drawings. The following embodiments are merely examples, and are not intended to limit the scope of the present invention.

### First Embodiment

A light-shielding coordinate input apparatus will be exemplified as the first embodiment of a coordinate input apparatus according to the present invention. In particular, the first embodiment will explain an arrangement which corrects a coordinate value accompanying an up event, thereby reducing unexpected cancellation of an operation expected by the user.

<Overall Apparatus Arrangement>

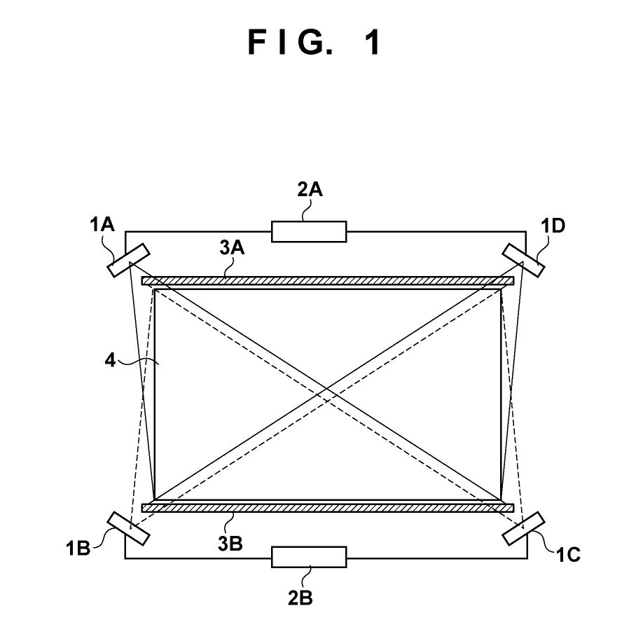

FIG. 1 is a view showing the schematic arrangement of the coordinate input apparatus according to the first embodiment. Four sensor units 1A to 1D each including a light-projecting unit and light-receiving unit are arranged at predetermined distances from each other around an input region 4 where the user performs input using a pointer. The sensor units 1A and 1D are connected to a control/calculation unit 2A which performs control/calculation. The sensor units 1B and 1C are connected to a control/calculation unit 2B which performs control/calculation. Each sensor unit receives a control signal from the connected control/calculation unit, and transmits a signal detected by the light-receiving unit to the control/calculation unit. Details of the arrangements of the sensor unit and control/calculation unit will be described later.

Retroreflective portions 3A and 3B include retroreflective surfaces which reflect reflected light in the incoming direction of incident light. That is, the retroreflective portion retroreflects light projected from the light-projecting unit of the sensor unit toward the same sensor unit. The reflected light is one-dimensionally detected by the light-receiving unit of the sensor unit which is formed from a condensing optical system, line CCD, and the like. The light amount distribution is sent to the control/calculation unit.

In the first embodiment, the retroreflective portions are formed on two facing sides of the input region 4. The sensor units 1A and 1D project light to the retroreflective portion 3B, and receive retroreflected light. Similarly, the sensor units 1B and 1C project light to the retroreflective portion 3A, and receive retroreflected light. When there is an input pointed by the pointer in the input region 4, light projected from the light-projecting unit is shielded, no retroreflected light is obtained, and no light amount is obtained from only the input pointed position. Note that the sensor units are arranged outside the input region 4. The input region 4 is usable as an interactive input device by forming it from the display screen of a display device such as a PDP, rear projector, or LCD panel, or projecting an image by a front projector.

The control/calculation units can communicate with each other, and detect the light-shielding range of an input pointed portion from a change of the light amount that has been detected by the sensor units 1A to 1D. Coordinates in the input region are calculated from the direction (angle) of the light-shielding range, the distance between the sensor units, and the like. The coordinate input apparatus outputs the determined coordinate value of the input position to a host apparatus (not shown) or the like connected to the coordinate input apparatus via an interface such as a USB interface.

The coordinate input apparatus generates an event signal (one of a move event, down event, and up event) after calculating the coordinate value. The move event represents a state in which the cursor is moved. The down event represents a pointer detection state (incoming of the pointer to the detection region). The up event represents a change from the pointer detection state to a non-detection state (outgoing of the pointer from the detection region).

<Detailed Description of Sensor Unit>

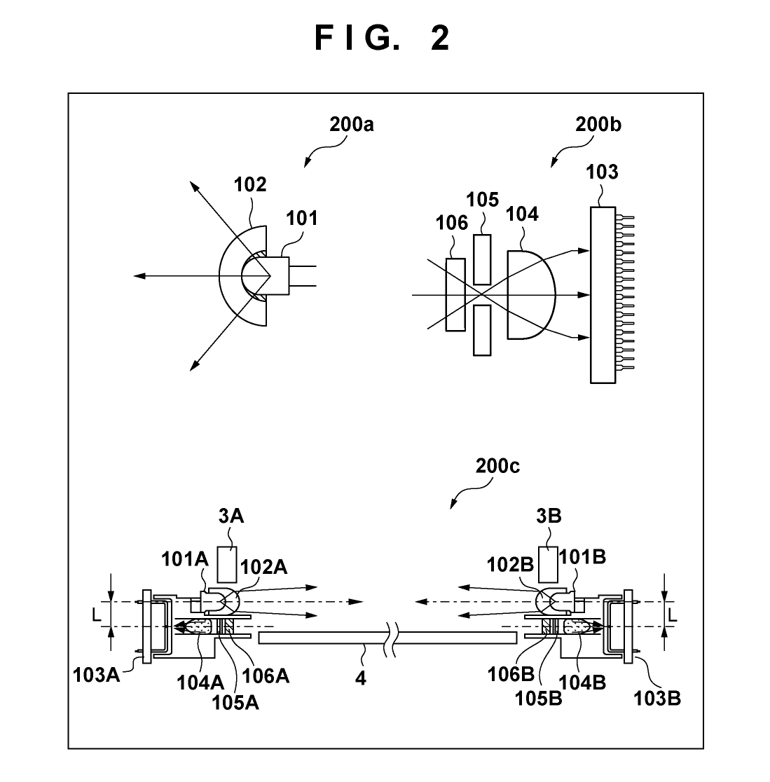

FIG. 2 is a view showing the detailed arrangement of the sensor unit of the coordinate input apparatus according to the first embodiment. Each of the sensor units 1A to 1D is roughly formed from a light-projecting unit 200a and light-receiving unit 200b.

The light-projecting unit 200a of the sensor unit includes an infrared LED 101 for emitting infrared light. The infrared LED 101 projects light within the range of the retroreflective portion 3 via a light-projecting lens 102. The infrared LED 101 and light-projecting lens 102 implement the light-projecting unit in each of the sensor units 1A to 1D. Infrared light projected by the light-projecting unit is retroreflected by the retroreflective portion 3 in the incoming direction. The light-receiving unit in each of the sensor units 1A to 1D detects the light.

The light-receiving unit 200b of the sensor unit includes a 1D line CCD 103, a light-receiving lens 104 serving as a condensing optical system, a stop 105 which restricts the incident direction of incident light within the range of the retroreflective portion 3, and an infrared filter 106 which prevents entrance of unwanted light (disturbance light) such as visible light. More specifically, infrared light reflected by the retroreflective portion 3 passes through the infrared filter 106 and stop 105, and is condensed on the detection element surface of the line CCD 103 via the light-receiving lens 104.

A section when viewed from the sensor units 1A and 1B in FIG. 1 is shown in 200c. Light from the infrared LED 101A of the sensor unit 1A is projected mainly to the retroreflective portion 3B as a beam which is restricted by the light-projecting lens 102A to be almost parallel to the coordinate input surface. Similarly, light from the infrared LED 101B of the sensor unit 1B is projected mainly to the retroreflective portion 3A via the light-projecting lens 102B.

The light-projecting unit and light-receiving unit are overlaid in a direction perpendicular to the input region 4 serving as the coordinate input surface. When viewed from the front (direction perpendicular to the coordinate input surface), the light emission center of the light-projecting unit and the reference position (corresponding to a reference point position for measuring an angle (to be described later), and the position of the stop 105) of the light-receiving unit coincide with each other.

The retroreflective portion 3 retroreflects, in the incoming direction of light, light which is a light beam projected from the light-projecting unit to be almost parallel to the coordinate input surface and is projected at a predetermined angle within the plane. The light is condensed to form an image on the detection element surface of the line CCD 103 via the infrared filter 106A (106B), stop 105A (105B), and light-receiving lens 104A (104B). An output signal from the line CCD 103 outputs a light amount distribution corresponding to the incident angle of reflected light. Hence, the pixel number of each pixel which forms the line CCD 103 corresponds to the incident angle.

Note that the distance L between the light-projecting unit and the light-receiving unit represented in 200c is a value much smaller than the distance from the light-projecting unit to the retroreflective portion 3. Even at the distance L, the light-receiving unit can detect sufficient retroreflected light.

<Detailed Description of Control/calculation Unit>

The control/calculation units 2A and 2B and the sensor units 1A to 1D exchange CCD control signals, CCD clock signals, CCD output signals, and LED driving signals.

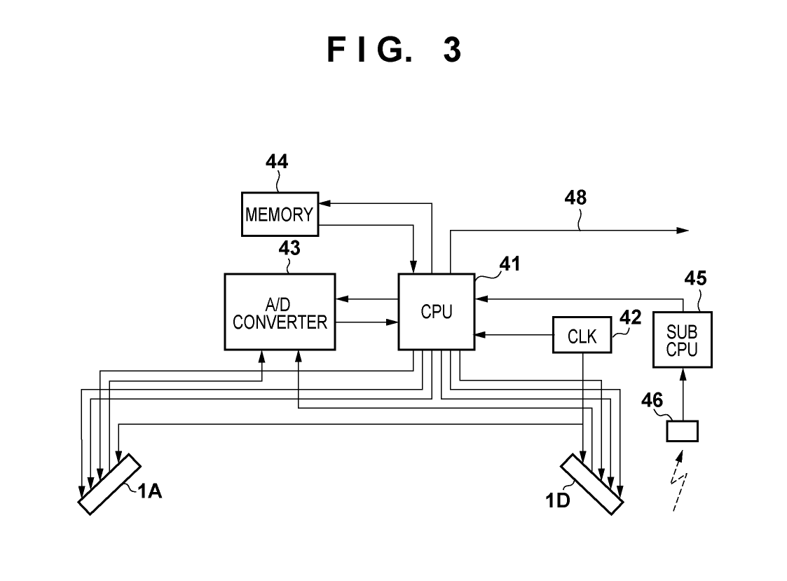

FIG. 3 is a block diagram showing the control/calculation unit. Note that the control/calculation units have the same circuit arrangement.

A CPU 41 formed from a one-chip microcomputer or the like outputs a CCD control signal to control the shutter timing of the CCD serving as the light-receiving unit of the sensor unit, data output, and the like. A CCD clock is transmitted from a clock generator CLK 42 to the sensor unit, and is also input to the CPU 41 to perform various control operations in synchronism with the CCD. Note that the CPU 41 similarly outputs an LED driving signal, and supplies it to the infrared LED serving as the light-projecting unit of the sensor unit.

A detection signal from the CCD serving as the light-receiving unit of the sensor unit is input to an A/D converter 43 of the control/calculation unit, and converted into a digital value under the control of the CPU 41. The converted digital value is stored in a memory 44, and used to calculate an angle. A coordinate value is obtained from the calculated angle, and output to an external PC or the like via a serial interface 48 or the like. Note that the serial interface 48 connects either the control/calculation unit 2A or 2B to the PC.

In the first embodiment, the sensor units and control/calculation units are arranged separately above and below the input region 4, as described with reference to FIG. 1. Communication between the upper and lower control/calculation units uses, for example, wireless communication. For example, the control/calculation units exchange data processed by sub-CPUs 45 via infrared communication interfaces 46.

Note that the control/calculation units 2A and 2B operate by master-slave control. For example, the control/calculation unit 2A is a master, and the control/calculation unit 2B is a slave. Note that each control/calculation unit can serve as either a master or slave, and can be switched by inputting a switching signal to a CPU port by a DIP switch (not shown) or the like. The master control/calculation unit 2A transmits, to the slave control/calculation unit 2B via each interface, a control signal for controlling the timing to transmit the control signal of each sensor unit.

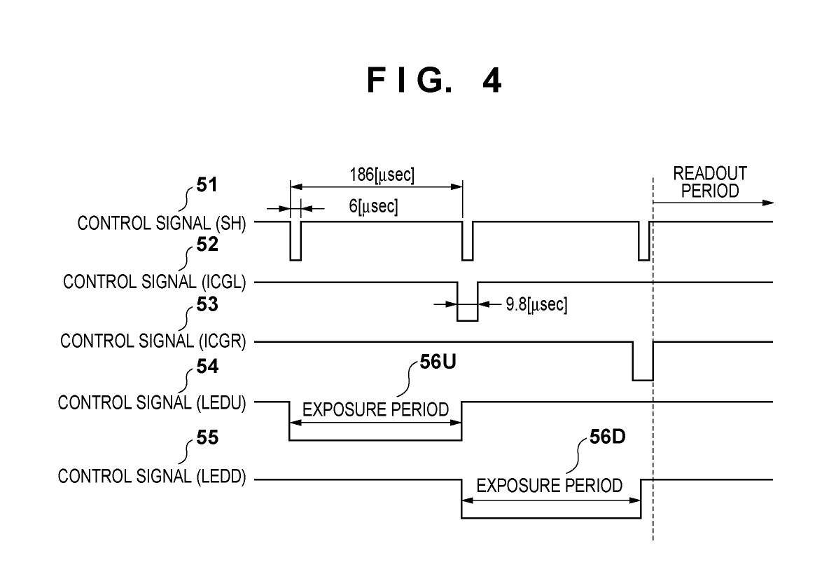

FIG. 4 is a timing chart showing control signals. Control signals 51, 52, and 53 are control signals for controlling the CCD. An interval represented by the control signal 51 (SH) determines the shutter release time of the CCD. The control signals 52 and 53 are gate signals to the upper sensor units (sensor units 1A and 1D) and the lower sensor units (sensor units 1B and 1C). The control signals 52 and 53 are signals for transferring charges in the internal photoelectric converters of the CCDs to reading units.

Control signals 54 and 55 are LED driving signals. To turn on the LEDs of the upper sensor units in the first cycle of the control signal 51 (SH), the driving signal of the control signal 54 (LEDU) is supplied to the LEDs via LED driving circuits. To turn on the LEDs of the lower sensor units in the next cycle, the driving signal of the control signal 55 (LEDD) is supplied to the LEDs via LED driving circuits. After the end of driving the LEDs of the upper and lower sensor units, CCD signals are read out from the sensors. Hence, the upper and lower sensor units project light at different timings (exposure periods 56U and 56D), and a plurality of data (light amount distributions) received by the respective CCDs are read out.

<Description of Detection of Light Amount Distribution>

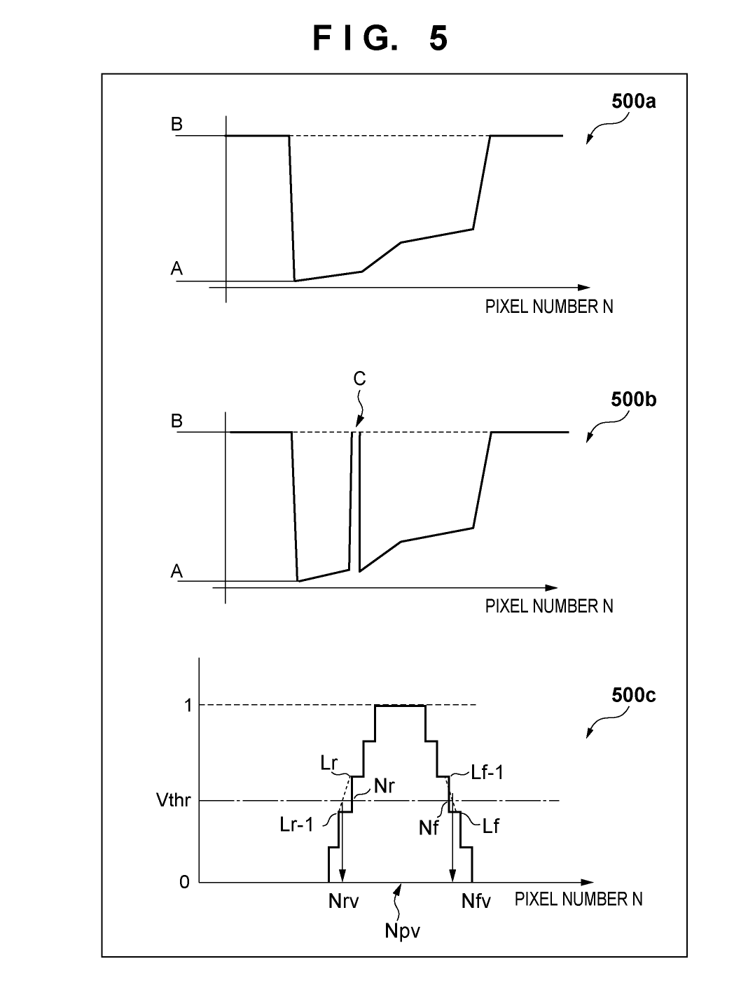

FIG. 5 is a view exemplifying a light amount distribution output from the sensor unit.

When there is no input to the input region 4 by the pointer, for example, a light amount distribution as denoted by 500a is obtained as an output from each sensor unit. Needless to say, the light amount distribution shown in FIG. 5 is merely an example, and the light amount distribution changes depending on the characteristics of the retroreflective sheet, those of the LED, or a change over time (for example, dirt on the reflecting surface). In 500a, level A indicates a maximum light amount, and level B indicates a minimum light amount. Data (light amount distribution) output from the CCD is sequentially A/D-converted and input as digital data to the CPU.

In an output example 500b, there is an input to the input region 4 by the pointer, that is, reflected light is shielded. In 500b, a portion C corresponds to a position where the pointer shields reflected light. Only at this portion, the light amount decreases (drops to level B).

More specifically, a light amount distribution free from an input as represented by 500a is stored in advance, and a light amount distribution as represented by 500b is detected in each sampling period shown in FIG. 4. Based on the difference (light-shielding range) between these light amount distributions, an input angle can be determined as an input point by the pointer.

<Description of Angle Calculation>

In angle calculation, the above-described light-shielding range is detected. Although data from one sensor unit will be described, the same processing is performed for the remaining sensor units.

First, upon power ON, a CCD output in a state in which there is no input by the pointer and the light-projecting unit does not project light is A/D-converted and stored as Bas_Data[N] in the memory. This data contains variations of the CCD bias and the like, and is data near level B in 500a. Note that N is a pixel number, and a pixel number corresponding to an effective input range is used. Then, a light amount distribution in a state in which there is no input by the pointer and the light-projecting unit projects light is stored. This light amount distribution corresponds to data indicated by a solid line in 500a, and is represented as Ref_Data[N].

Data in a given sample period is represented as Norm_Data[N]. Then, it is determined using Bas_Data[N] and Ref_Data[N] whether there is a light-shielding range. It is periodically determined whether there is an input to the input region 4 by the pointer and the pointer exists in the detection region.

To specify a light-shielding range, the presence/absence of an input is determined from the absolute value of a change of data in order to prevent a determination error caused by noise or the like and detect a reliable change of a predetermined amount. More specifically, the absolute change amount is calculated as follows in each pixel, and compared with a predetermined threshold Vₜₕₐ:

Norm_Data_{—}A[N]=Norm_Data[N]−Ref_Data[N ](1)

where Norm_Data_A[N] is the absolute change amount in each pixel. This processing only calculates the difference between two data and compares it, and does not take a long processing time. Hence, the presence/absence of an input can be determined quickly. When pixels in which the absolute change amount has exceeded Vₜₕₐ for the first time are detected by more than a predetermined number, it is determined that there is an input.

For higher-accuracy detection, the change ratio may be calculated to determine an input point. More specifically, the change ratio is calculated as follows in each pixel, and compared with a predetermined threshold Vₜₕᵣ:

Norm_Data_{—}R[N]=Norm_Data[N]/(Bas_Data[N]−Ref_Data[N]) (2)

The threshold Vₜₕᵣ is applied to the obtained Norm_Data_R[N]. The center between pixel numbers corresponding to the leading and trailing edges is set as an input pixel. Then, an angle is obtained.

Detection based on calculation of the ratio is exemplified in 500c. Assume that, upon detection using the threshold Vₜₕᵣ, the leading edge of the light-shielding region exceeds the threshold in a pixel having a pixel number Nᵣ. Also, assume that the trailing edge becomes lower than Vₜₕᵣ in a pixel having a pixel number N_{f}. In this case, a center pixel Nₚ may be simply calculated as

Nₚ=Nᵣ+(N_{f}−Nᵣ)/2 (3)

However, the pixel interval becomes a minimum resolution. For finer detection, a virtual pixel number at which the level of a pixel crosses the threshold is calculated using the level of each pixel and the level of a pixel having an immediately preceding pixel number, as represented by equations (4) to (6).

Lᵣ is the level of a pixel having a pixel number Nᵣ, and Lᵣ₋₁ is the level of a pixel having a pixel number Nᵣ₋₁. L_{f} is the level of a pixel having a pixel number N_{f}, and L_{f-1} is the level of a pixel having a pixel number N_{f-1}. At this time, virtual pixel numbers Nᵣᵥ and N_{fv} can be calculated as

Nᵣᵥ=Nᵣ−1+(Vₜₕᵣ−Lᵣ₋₁)/(Lᵣ−Lᵣ₋₁) (4)

N_{fv}=N_{f}−1+(Vₜₕᵣ−L_{f-1})/(L_{f}−L_{f-1}) (5)

A virtual center pixel Nₚᵥ is calculated as

Nₚᵥ=Nᵣᵥ+(N_{fv}−Nᵣᵥ)/2 (6)

By calculating a virtual pixel number using pixel numbers and the levels of pixels having these pixel numbers, higher-resolution detection can be achieved.

To calculate an actual coordinate value from the thus-obtained center pixel number, the center pixel number needs to be converted into angle information. However, in actual coordinate calculation to be described below, it is convenient to obtain not an angle itself but the tangent value of the angle. Therefore, the tangent is obtained here. Note that a pixel number can be converted into a tangent tan θ by looking up a table or using a predetermined transformation. When a transformation is used, a larger number of orders of a polynomial can ensure higher accuracy, but increases the calculation amount. Hence, the number of orders of a polynomial is determined in consideration of the calculation ability, accuracy specification, and the like.

For example, when a fifth-order polynomial is used, tan θ can be derived using six coefficients L₅, L₄, L₃, L₂, L₁, and L₀:

tan θ=((((L₅×Nₚᵣ+L₄)×Nₚᵣ+L₃)×Nₚᵣ+L₂)×Nₚᵣ+L₁)×Nₚᵣ+L₀ (7)

Coefficient data are stored in a nonvolatile memory or the like in shipment or the like.

By executing the same processing for the respective sensor units, respective angle data can be determined. Although tan θ is obtained directly in the above example, it is also possible to obtain another value (for example, angle) and then derive tan θ.

<Description of Coordinate Calculation Method>

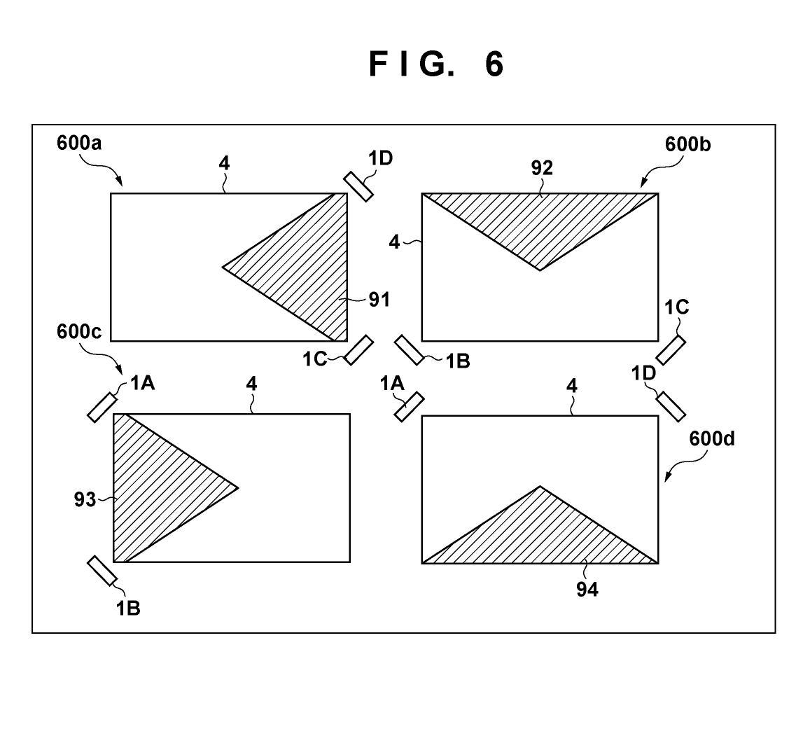

FIG. 6 shows the coordinate detection range of the input region 4 capable of coordinate calculation by a combination of the sensor units. As shown in FIG. 6, a region where the light-projecting and light-receiving ranges of the respective sensor units cross each other serves as a region capable of coordinate calculation. A range capable of coordinate calculation by the sensor units 1C and 1D is a hatched range 91. Similarly, a range capable of coordinate calculation by the sensor units 1B and 1C is a hatched range 92, a range capable of coordinate calculation by the sensor units 1A and 1B is a hatched range 93, and a range capable of coordinate calculation by the sensor units 1A and 1D is a hatched range 94. To cover the entire input region 4 by the four ranges 91 to 94, the ranges may have overlapping regions.

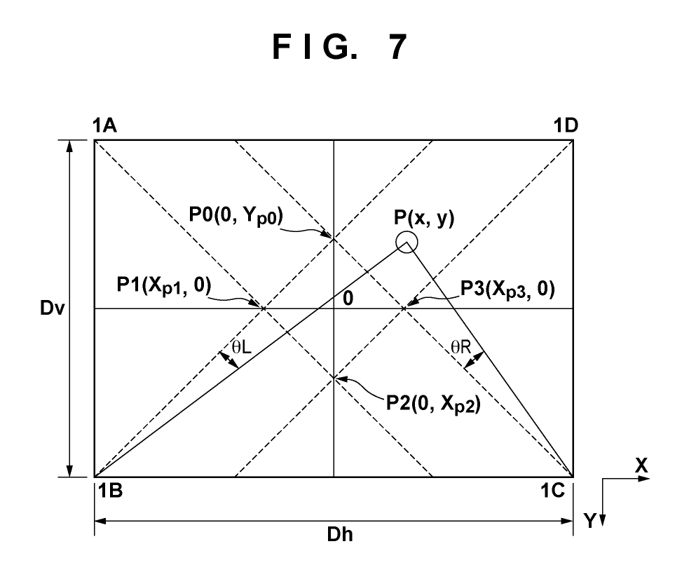

FIG. 7 is a view showing a positional relationship with screen coordinates. When there is an input by the pointer at the position of a point P, the sensor units 1B and 1C detect light-shielding data. Note that Dh is the distance between the two sensor units, the center of the screen is an origin position, and P0 (0, Y_{PO}) is the intersection point of the reference angles of the sensor units 1B and 1C and the Y-axis. Let θ_{L} and θ_{R} be angles defined by reference angles and vectors to the point P in the sensor units 1B and 1C, respectively. Then, tan θ_{L} and tan θ_{R} are calculated using the above-mentioned polynomial. At this time, the coordinates of the point P are calculated by

x=Dh×(tan θ_{L}+tan θ_{R})/(1+(tan θ_{L}+tan θ_{R})) (8)

y=−Dh×(tan θ_{R}−tan θ_{L}−(2×tan θ_{L}×tan θ_{R}))/(1+(tan θ_{L}+tan θ_{R})+Y_{P0} (9)

As described above, a combination of the sensor units for use changes depending on the position of the point P in the input region. The parameters of the coordinate calculation equation change depending on a combination of the sensor units. For example, in calculation using data detected by the sensor units 1C and 1D, equations (8) and (9) use values shown in FIG. 7. More specifically, transformation of Dh→Dv and Y_{P0}→X_{P1} is executed. Also, when light-shielding data are detected by a combination of the sensor units 1A and 1B and a combination of the sensor units 1A and 1D, the parameters are changed to calculate the position of the point P in accordance with equations (8) and (9).

As described with reference to FIG. 6, the ranges 91 to 94 detected by pairs of the sensor units include overlapping regions. That is, an input by one pointer may be detected by different pairs of the sensor units. In this case, for example, a plurality of coordinate values detected by respective pairs of the sensor units are averaged.

<Apparatus Operation>

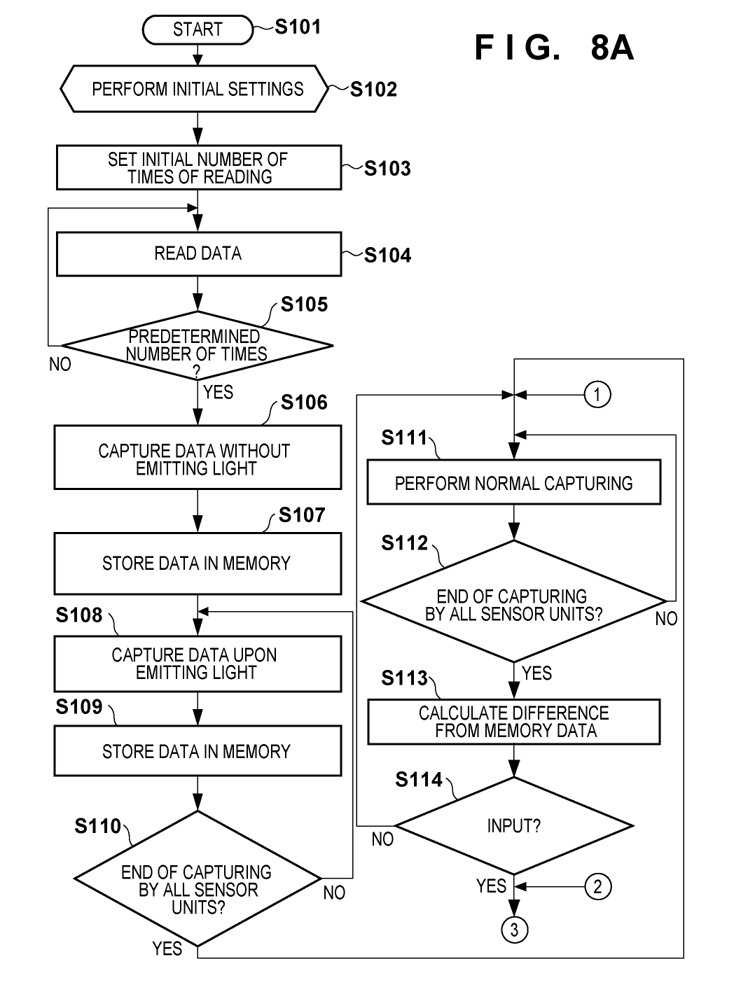

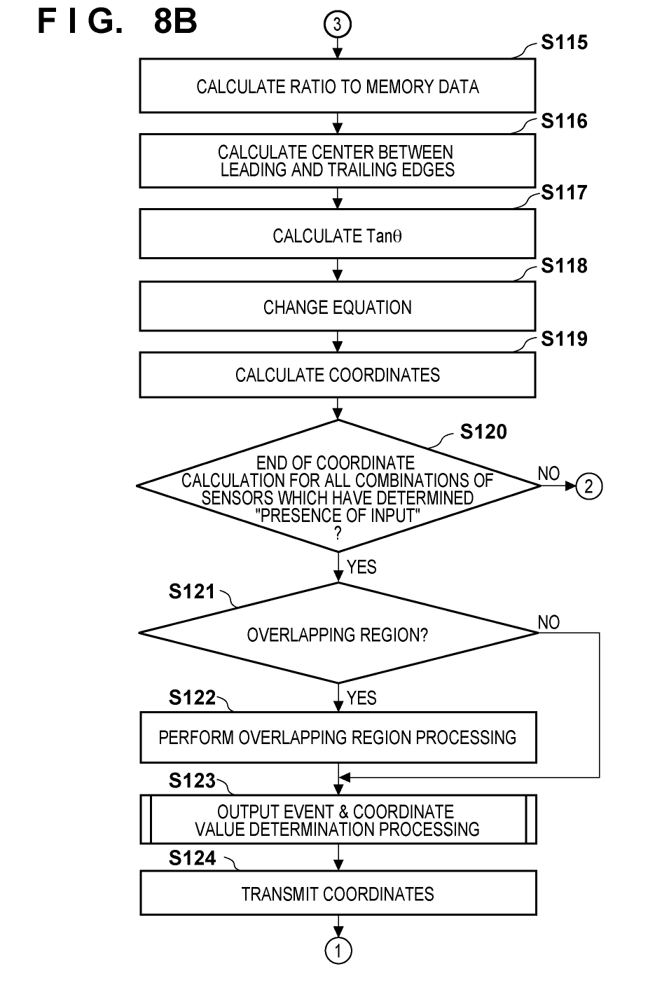

FIGS. 8A and 8B are flowcharts showing the operation of the control/calculation unit in the coordinate input apparatus according to the first embodiment. Note that steps S101 to S110 represent an initial setting operation to be performed only upon power ON, and steps S111 to S124 represent a normal capturing operation to be performed in each sampling period.

Upon power ON in step S101, various initialization operations such as port setting and timer setting of the CPU and the like are performed in step S102.

In step S103, a preparation operation is performed to remove unwanted charges because of the following reason. In some cases, unwanted charges are stored in a photoelectric converter such as a CCD during a non-operating period. If the data is directly used as reference data, this may cause a detection failure/detection error. To prevent this, data is read out by a plurality of times at the beginning without emitting light. More specifically, the number of times of reading is set in step S103, and data is read out by a predetermined number of times in step S104, thereby removing unwanted charges. In step S105, it is determined whether reading has been repeated by the predetermined number of times.

Data (Bas_Data[N] described above) which has been obtained without emitting light and is used for reference data is captured in step S106, and is stored in the memory in step S107. Then, data (Ref_Data[N] described above) which is the other data used for reference data and corresponds to an initial light amount distribution upon emitting light is captured in step S108, and is stored in the memory in step S109. In step S108, data is captured by emitting light from the pair of upper sensor units and the pair of lower sensor units at different timings. This is because the upper sensor units and lower sensor units face each other, and if they emit light simultaneously, their light-receiving units detect the light beams emitted by the facing sensor units. In step S110, it is determined whether all the sensor units have ended capturing. Steps S108 and S109 are repeated until all the sensor units have ended capturing.

In step S111, the light amount distribution Norm_Data[N] is captured in each sampling period. In step S112, it is determined whether all the sensor units have ended capturing. Step S111 is repeated until all the sensor units have ended capturing.

If it is determined in step S112 that all the sensor units have ended capturing, difference values between all data and Ref_Data[N] are calculated in step S113, and the presence/absence of a light-shielding portion is determined in step S114. If it is determined in step S114 that there is no light-shielding region, the process returns to step S111 without any processing. At this time, if the repetitive cycle of the sampling period is set to 10 [msec], sampling is executed 100 times per sec.

If it is determined in step S114 that there is a light-shielding region, the ratio is calculated in step S115 in accordance with equation (2). In step S116, the leading and trailing edges of the calculated ratio are determined using a threshold, and center coordinates (pixel number) are calculated in accordance with equations (4), (5), and (6). In step S117, Tan θ is calculated by an approximate polynomial based on the center coordinates obtained in step S117.

In step S118, parameters such as the distance between the sensors in equations (8) and (9), other than Tan θ, are selected based on a combination of the sensor units which have determined that there is a light-shielding region. Then, an equation corresponding to the combination of the sensor units is determined. In step S119, x- and y-coordinates are calculated from the Tan θ values of the sensor units using equations (8) and (9) determined in step S118.

In step S120, it is determined whether coordinate calculation has been performed for all combinations of the sensor units which have determined in step S114 that there is an input by the pointer. If coordinate calculation has not ended for all combinations, the process returns to the operation of step S115 to repetitively perform coordinate calculation. If it is determined in step S120 that coordinate calculation has been performed for all combinations, the process advances to step S121.

In step S121, it is determined whether the coordinate detection range shown in FIG. 6 is an overlapping region. In other words, it is determined whether a plurality of coordinate values have been calculated. If it is determined in step S121 that the coordinate detection range is an overlapping region, the process advances to step S122 to calculate one coordinate value using averaging or the like. If it is determined in step S121 that the coordinate detection range is not an overlapping region, the process advances to step S123.

In step S123, it is determined whether the coordinate value output as a result of the processes of steps S111 to S122 represents a touch. A cursor event signal (one of a move event, down event, and up event described above) to be used in the application of the host apparatus is generated based on the determination result, and associated with the coordinate value. Details of event signal generation will be described later.

In step S124, the coordinate value and cursor event signal which have been determined in step S123 are output (transmitted) to, for example, the host apparatus. The coordinate value and cursor event signal can be output via an arbitrary interface including a serial communication interface such as a USB or RS232 interface. In the host apparatus, a device driver corresponding to the coordinate input apparatus interprets the received data, and operates the host apparatus based on the interpreted coordinate value, cursor event signal, and the like. For example, movement of the cursor, an instruction to a button object, and the like are executed based on the interpreted coordinate value, cursor event signal, and the like. After the end of the processing of step S124, the process returns to the operation of step S111. The above processes are repeated till power OFF.

<Cursor Event Signal Generation & Output Coordinate Value Determination Operation>

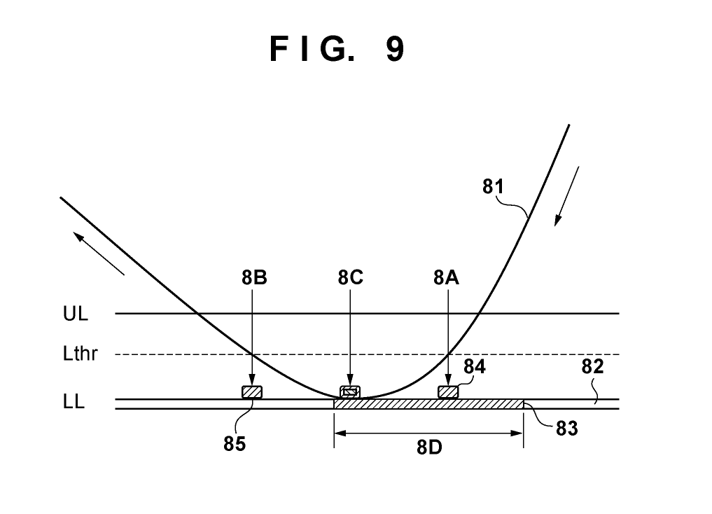

FIG. 9 is a view for explaining correction of a coordinate value to which an up event is assigned. FIG. 9 is a view conceptually showing the section of the input surface when viewed from the side. A detection region is arranged in the top layer of the input surface. Assume that the user moves the pointer along an input locus 81 and tries to touch an object 83 displayed on the screen.

The width (height) of the optical path in the section is represented as a region (detection region) between a lower limit level LL and an upper limit level UL in detection. When the pointer is inserted to interrupt the optical path, a coordinate value is calculated at a position 8A where the pointer crosses a level Lₜₕᵣ (direction in which the pointer comes close to the input surface) at which the presence of an input is detected. Further, a down event is generated. That is, a cursor event is generated based on a change of the presence/absence of light shielding (change of the presence/absence of the pointer). After that, coordinate calculation continues in a region closer to the input surface than the level Lₜₕᵣ at which the coordinate input apparatus reacts to detect an input. During this period, a down event remains generated. At a position 8B, the pointer crosses the level Lₜₕᵣ (direction in which the pointer moves apart from the input surface) at which the coordinate input apparatus reacts to detect an input, so no down event is generated any more. Thus, generation of a down event, and detection of a coordinate value to which the down event is assigned are performed between the coordinate value of the position 8A and a coordinate value before one cycle of the position 8B.

As described in Description of the Related Art, the button object 83 reacts only within a region 8D. Even if an up event is assigned to the coordinate value of the position 8B and output to the host apparatus, an object event corresponding to the button object 83 is not generated.

Hence, the coordinate input apparatus according to the first embodiment calculates the coordinate value of the middle point of a line segment connecting the coordinate value of the position 8A serving as a start point at which the pointer crosses the level Lₜₕᵣ at which the coordinate input apparatus reacts to detect an input, and the coordinate value of the position 8B serving as an end point. That is, the coordinate input apparatus calculates the coordinate value of the middle point of a line segment connecting a coordinate value upon detecting outgoing and a coordinate value upon detecting incoming prior to the outgoing. The coordinate input apparatus associates an up event with the calculated coordinate value of the middle point, and outputs them to the host apparatus. In FIG. 9, an up event is assigned to a middle point position 8C calculated from the positions 8A and 8B, and output to the host apparatus. Since the coordinate value of the middle point position 8C falls within the region 8D, an object event corresponding to the button object is generated.

Note that the middle point of two coordinate values at which the pointer crosses the level Lₜₕᵣ has been exemplified as a corrected coordinate value. It is also possible to set weight information for the two coordinate values and output, as a corrected value, an arbitrary coordinate value on a line segment connecting the two coordinate values. For example, a coordinate value (coordinate value of the position 8A in FIG. 9) when the pointer crosses Lₜₕᵣ in the direction in which the pointer comes close to the input surface may be associated with an up event and output. For example, the average value of a plurality of coordinate values within a range where the pointer exceeds the level Lₜₕᵣ may be calculated. Alternatively, the plurality of coordinate values may be weighted by a distance per sampling period to calculate an average value. This method is effective when the level at which the coordinate input apparatus reacts to detect an input by the pointer is changed between the direction in which the pointer comes close to the input surface and the direction in which it moves apart from the input surface.

Note that whether to correct a coordinate value to be associated with an up event may be determined based on whether the distance between two coordinate values at which the pointer crosses the level Lₜₕᵣ exceeds a predetermined distance. The predetermined distance may be appropriately set in accordance with the application purpose of the coordinate input apparatus. For example, the predetermined distance may be determined in accordance with the size of an object displayed in the input region 4. It is also possible to define the size of the pointer (for example, the thickness of the user's finger) and set the predetermined distance.

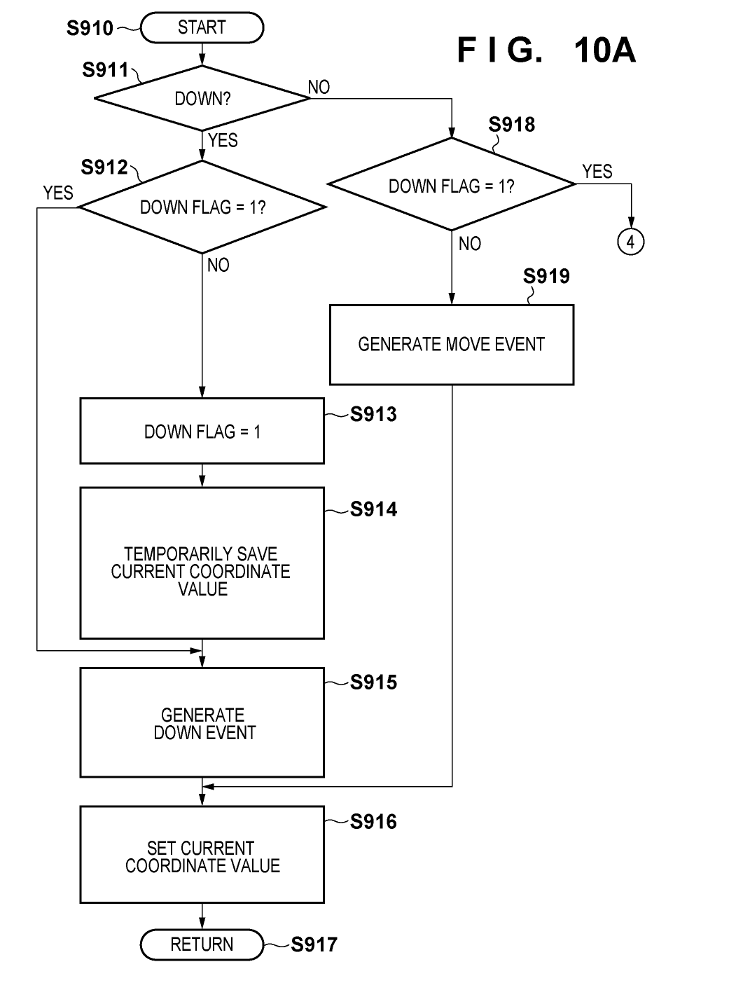

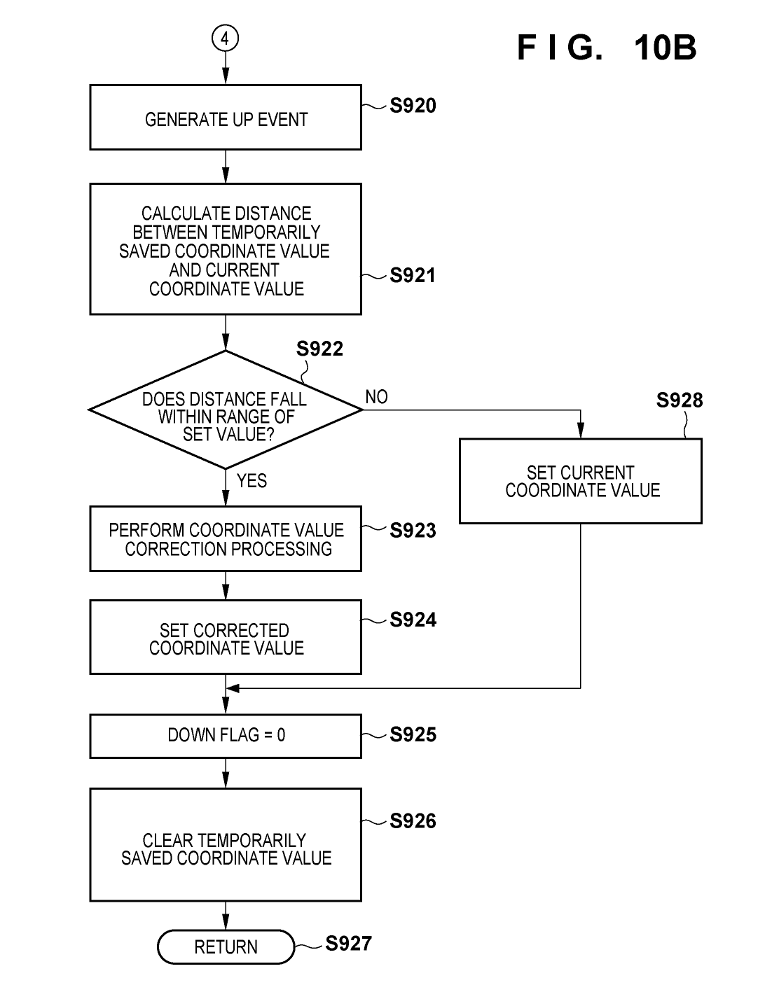

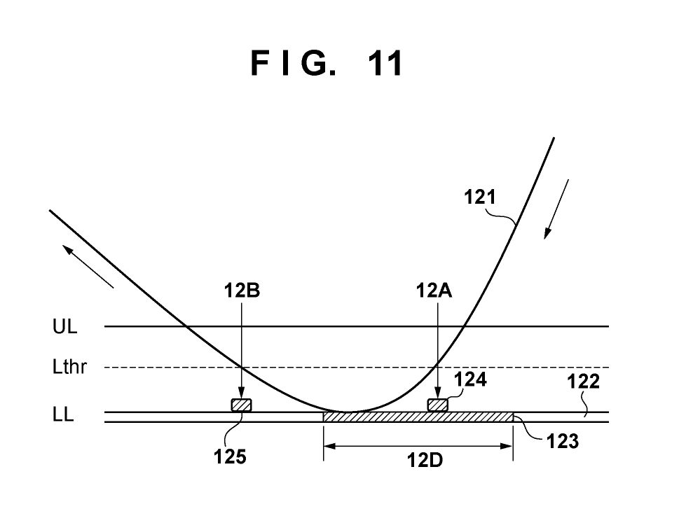

FIGS. 10A and 10B are flowcharts showing a detailed operation in a step (step S123) of determining an output event and coordinate value.

In step S910, the process starts. In step S911, it is determined whether the pointer is in the down state, that is, whether there is a light-shielding region. In this processing, a change amount of the light amount upon input as described above is compared with a predetermined threshold. If it is determined in step S911 that the pointer is in the down state, the process advances to step S912; if it is determined that the pointer is not in the down state, to step S918.

In step S912, it is determined whether “1” has been set in a down flag representing whether the pointer is in the down state. Note that the initial value of the down flag is “0” (not in the down state). If it is determined in step S912 that the down flag is “0”, the process advances to step S913 to set “1” in the down flag. The process then advances to step S914 to temporarily save the current coordinate value in a predetermined area of the memory. If it is determined in step S912 that the down flag is “1”, the down flag has already been set, and the process directly advances to step S915.

In step S915, a down event is generated as an event signal. In step S916, the current coordinate value is set in an output buffer or the like. In step S917, the process returns to the main routine to advance to step S124.

In step S918, it is determined whether the down flag is “1”. If it is determined that “1” has not been set in the down flag, the process advances to step S919 to generate a move event. Thereafter, the process advances to step S916 to set the current coordinate value in the output buffer. If it is determined in step S918 that “1” has been set in the down flag, the process advances to processing (step S920) pertaining to an up event.

An up event is generated in step S920, and the distance between the coordinate value saved in step S914 and the current coordinate value is calculated in step S921. In step S922, the distance calculated in step S921 is compared with the predetermined distance. If the distance calculated in step S921 is equal to or smaller than the predetermined distance, the process advances to step S923 to perform correction processing for a predetermined coordinate value (for example, calculation of a middle point between two points). In step S924, the corrected coordinate value is set in the output buffer. If the distance calculated in step S921 is larger than the predetermined distance, the current coordinate value is directly set in the output buffer in step S928 without correcting it.

In step S925, the down flag is cleared (“0” is set). In step S926, the coordinate value temporarily saved in step S914 is cleared. The process then advances to step S927 to return to the main routine and advance to step S124.

As described above, the coordinate input apparatus according to the first embodiment corrects a coordinate value to which an up event is assigned, and outputs it to the host apparatus. This can reduce unintended cancellation of an object event expected by the user, improving the operability.

(Modification 1)

In the first embodiment, the coordinate input apparatus determines the distance between two coordinate values at which the pointer crosses the level at which the coordinate input apparatus reacts to detect an input. Based on whether the distance falls within the range of a predetermined value, the coordinate input apparatus determines whether to correct a coordinate value. However, whether to correct a coordinate value may be determined based on another criterion. Assume that the input surface is associated with a graphical user interface (GUI). For example, the coordinate input apparatus receives, from a host apparatus (not shown) serving as an external device, information representing whether a coordinate value output from the coordinate input apparatus in association with a down event falls within the range of a predetermined GUI object (for example, button object). Only when the coordinate value falls within the range of the button object, the above-described correction may be executed. This can prevent an unintended correction operation when, for example, the user inputs a character using the pointer.

(Modification 2)

Output of an event signal may be controlled to cope with a case in which a coordinate value (down event) at which the pointer crosses the level at which the coordinate input apparatus reacts to detect an input in the direction in which the pointer comes close to the input surface is output outside the region 8D of the button object. More specifically, an up event→down event→up event are output to the corrected value (coordinate value of the position 8C in FIG. 9) of a coordinate value at which the pointer crosses the level at which the coordinate input apparatus reacts to detect an input in the direction in which the pointer moves apart from the input surface. Under this control, a pair of down and up events can be virtually generated for the button object to execute an event (for example, pressing of the button).

However, an application may interpret output of the cursor events as a “double tap” operation. To prevent this, the device driver in the host apparatus preferably adopts processing of, for example, ignoring repetition of a pair of down and up events within a predetermined time.

(Modification 3)

In the first embodiment, the coordinate input apparatus performs coordinate value correction processing. However, the present invention may implement a coordinate input system in which the coordinate input apparatus outputs a coordinate value detected by the sensor unit and transmits it to an external host apparatus (not shown), and the host apparatus executes the above-described coordinate correction processing. At this time, the coordinate correction processing is desirably performed by a device driver which is installed in the host apparatus and corresponds to the coordinate input apparatus.

More specifically, the coordinate input apparatus simply outputs, together with a down event or up event, a coordinate value at which the pointer crosses the level at which the coordinate input apparatus reacts to detect an input. Then, the device driver in the host apparatus determines a coordinate value to be output to an application, in accordance with the transmission interval between cursor event-assigned coordinate values, the coordinate value interval between the edges of respective events when a down event changes to an up event.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-213379, filed Sep. 28, 2011, which is hereby incorporated by reference herein in its entirety.

What is claimed is:

1. A coordinate input apparatus comprising:
a determination unit configured to periodically determine whether a pointer exists in a detection region arranged in a top layer of an input surface;
a derivation unit configured to derive a coordinate value of the pointer when said determination unit determines that the pointer exists in the detection region;
a detection unit configured to detect incoming of the pointer to the detection region and outgoing of the pointer from the detection region based on a change of presence/absence of the pointer by said determination unit; and
an output unit configured to output an event signal representing outgoing of the pointer together with a coordinate value associated with the outgoing when said detection unit detects the outgoing of the pointer,
wherein the coordinate value associated with the outgoing is a coordinate value obtained by correcting a coordinate value derived by said derivation unit upon detecting the outgoing by using a coordinate value derived by said derivation unit upon detecting incoming prior to the outgoing.

2. The apparatus according to claim 1, wherein the coordinate value associated with the outgoing is a coordinate value on a line segment connecting the coordinate value derived by said derivation unit upon detecting the outgoing and the coordinate value derived by said derivation unit upon detecting incoming prior to the outgoing.

3. The apparatus according to claim 1, wherein the coordinate value associated with the outgoing is a coordinate value of a middle point of a line segment connecting the coordinate value derived by said derivation unit upon detecting the outgoing and the coordinate value derived by said derivation unit upon detecting incoming prior to the outgoing.

4. The apparatus according to claim 1, wherein when a distance between the coordinate value derived by said derivation unit upon detecting the outgoing and the coordinate value derived upon detecting incoming prior to the outgoing exceeds a predetermined distance, said output unit suppresses the correction, and outputs the coordinate value derived by said derivation unit upon detecting the outgoing as the coordinate value associated with the outgoing.

5. The apparatus according to claim 1, wherein
the input surface is associated with a graphical user interface (GUI) of an external device,
the coordinate input apparatus further comprises:
a transmission unit configured to transmit, to the external device, the coordinate value of the pointer that has been derived by said derivation unit; and
a reception unit configured to receive, from the external device, information representing whether the coordinate value transmitted by said transmission unit falls within a range of a predetermined GUI object forming the GUI, and
upon receiving information representing that the coordinate value derived by said derivation unit upon detecting incoming prior to the outgoing does not fall within the range of the predetermined GUI object, said output unit suppresses the correction, and outputs the coordinate value derived by said derivation unit upon detecting the outgoing as the coordinate value associated with the outgoing.

6. The apparatus according to claim 5, wherein when the corrected coordinate value falls within the range of the predetermined GUI object and the coordinate value derived by said derivation unit upon detecting the incoming prior to the outgoing falls outside the range of the predetermined GUI object, said output unit outputs three event signals respectively representing outgoing, incoming, and outgoing of the pointer, together with the coordinate value associated with the outgoing.

7. A method of controlling a coordinate input apparatus, comprising the steps of:
periodically determining whether a pointer exists in a detection region arranged in a top layer of an input surface;
deriving a coordinate value of the pointer when the pointer is determined in the determination step to exist in the detection region;
detecting incoming of the pointer to the detection region and outgoing of the pointer from the detection region based on a change of presence/absence of the pointer in the determination step; and
outputting an event signal representing outgoing of the pointer together with a coordinate value associated with the outgoing when the outgoing of the pointer is detected in the detection step,
wherein the coordinate value associated with the outgoing is a coordinate value obtained by correcting a coordinate value derived in the derivation step upon detecting the outgoing by using a coordinate value derived in the derivation step upon detecting incoming prior to the outgoing.

8. A coordinate input system comprising a coordinate input apparatus and a host apparatus connected to the coordinate input apparatus,
said coordinate input apparatus including:
a determination unit configured to periodically determine whether a pointer exists in a detection region arranged in a top layer of an input surface;
a derivation unit configured to derive a coordinate value of the pointer when said determination unit determines that the pointer exists in the detection region;
a detection unit configured to detect incoming of the pointer to the detection region and outgoing of the pointer from the detection region based on a change of presence/absence of the pointer by said determination unit; and
an output unit configured to output an event signal representing outgoing of the pointer together with a coordinate value derived by said derivation unit upon detecting the outgoing when said detection unit detects the outgoing of the pointer, and
said host apparatus including:
an input unit configured to input an event signal and a coordinate value from said coordinate input apparatus; and
a correction unit configured to, when said input unit receives the event signal representing outgoing of the pointer, correct the coordinate value which has been input together with the event signal and is associated with the outgoing, by using a coordinate value which has been input ahead by said input unit together with an event signal representing incoming of the pointer and is associated with the incoming.

9. A coordinate input apparatus comprising:
a detection unit configured to detect incoming and outgoing of a detection target to and from a coordinate detection region arranged at a top of an input surface;
a calculation unit configured to calculate a third coordinate value using a first coordinate value obtained when the detection target is detected to have come into the detection region, and a second coordinate value obtained when the detection target goes out from the detection region; and
an output unit configured to output the third coordinate value calculated by said calculation unit.

10. A method of controlling a coordinate input apparatus, comprising the steps of:
detecting incoming and outgoing of a detection target to and from a coordinate detection region arranged at a top of an input surface;
calculating a third coordinate value using a first coordinate value obtained when the detection target is detected to have come into the detection region, and a second coordinate value obtained when the detection target goes out from the detection region; and
outputting the third coordinate value calculated in the calculation step.
